(19) United States
(12) Patent Application Publication
(10) Pub. No.: US 2026/0147410 A1
(43) Pub. Date: May 28, 2026

(54) AUGMENTED READER AND METHOD FOR AUGMENTED READING OF TEXTS

(71) Applicant: ORANGE, Issy-les-Moulineaux (FR)

(72) Inventors: Christian Gregoire, Chatillon (FR); Cyril Plapous, Chatillon (FR); Yann Michel Almeras, Chatillon (FR)

(21) Appl. No.: 18/867,618

(22) PCT Filed: May 30, 2023
(86) PCT No.: PCT/EP2023/064454

§ 371 Date: Nov. 20, 2024

(30) Foreign Application Priority Data
May 31, 2022 (FR) FR2205205

(51) Int. Cl. G06F 3/01; G06F 40/166

(52) U.S. Cl. CPC G06F 3/015; G06F 3/017; G06F 40/166

(57) ABSTRACT

An augmented reader and a method for augmented reading of text. The augmented text reader includes at least one controller which is able to control an action relating to a portion of text, the action being a function of a received neural signal. Thus, a user will not have to manipulate real or virtual content containing the text in order to trigger the control of the action. This will facilitate the accessibility of reading real or virtual content, including for users with a disability but also whatever the context in which the content is read by the user, notably in a work context where the user is manipulating tools etc.

### TECHNICAL FIELD

The invention relates to an augmented reader and a method for augmented reading of texts.

### PRIOR ART

When reading a paper book, highlighting text, taking notes, searching for the meaning of a word in a dictionary or marking a page makes use of external equipment (pencil, paper, dictionary, bookmark), which makes it necessary to stop reading. Indeed, manipulating an object other than the book makes it necessary to be able to hold the book only with one hand, or even to have to put the book down.

Furthermore, highlighting and folding a page as a bookmark damage the book, which is not necessarily desirable either.

Technologies such as the e-book may facilitate certain actions but have limitations and drawbacks. The e-book requires manipulation in order to access the functions (which is inaccessible to certain types of disabilities or in certain contexts of use).

Using voice recognition might then be envisaged. However, the voice may not be used in an environment which requires discretion or in noisy environments.

In addition, these technologies apply only to e-books, not to paper content or to other reading media.

### DISCLOSURE OF THE INVENTION

One of the aims of the present invention is to provide improvements with respect to the prior art.

One subject of the invention is an augmented text reader comprising at least one controller which is able to control an action relating to a portion of text, the action being a function of a received neural signal.

Thus, the user will not have to manipulate the real or virtual content comprising the text in order to trigger the control of the action. This will facilitate the accessibility of reading real or virtual content, including for users with a disability but also whatever the context in which the content is read by the user, notably in a work context where the user is manipulating tools etc.

Advantageously, the portion of the text is a function of gaze tracking data from a user.

Thus, the action may be carried out on the entirety of the text or only a part of it.

Advantageously, the portion of the text is an area of text captured as a function of the gaze tracking data.

Thus, the action may be carried out on text printed on a real medium.

Advantageously, the augmented text reader comprises a gaze tracking device providing gaze tracking data from a user.

Advantageously, the augmented text reader comprises a text sensor which is able to capture an area of text as a function of gaze tracking data, the captured area of text constituting the part of text.

Advantageously, the augmented text reader comprises an analyzer which is able to determine a gesture of a user in relation to the portion of text as a function of the received neural signal.

Thus, the controlled action corresponds to a real action which would be carried out by the gesture of the user if the gesture was real and the medium of the text was real.

Advantageously, the gesture is a real or simulated gesture.

Thus, even a user in a situation where the gesture cannot really be executed may trigger the controller to control the action by mentally simulating this gesture.

Advantageously, the controller controls one or more of the following devices:
a text editor,
a translator,
a dictionary,
a robotic manipulator of real textual content,
a voice synthesizer,
an augmented reality system.

Thus, the controller respectively controls:
functions for editing the text, such as highlighting the part of the text, adding a note in relation to this part of the text, a bookmark etc.,
translation of the portion of the text into either a predefined language or a language selected by another neural signal,
provision of a definition of a word corresponding to the part of text, or even an encyclopedia article corresponding to the field to which the portion of text relates,
movements of a robotic manipulator, notably of a robot arm (making it possible to turn a page, close content, open content on a bookmark, introduce a bookmark, fold a page, highlight text etc.),
vocal reproduction of the text of the part of text,
reproduction, in augmented reality, of the elements generated by other controlled devices (highlighting, translation, definition, bookmark etc.).

Advantageously, the augmented text reader comprises one or more of the controlled devices.

Advantageously, the reader comprises a register which is able to store information generated by implementing the action relating to the text.

Thus, the text may be reconsulted subsequently by the user both in its published edition and in its version enriched by the user.

Another subject of the invention is a method for augmented reading of texts comprising at least one control of an action relating to a portion of text, the action being a function of a received neural signal.

Advantageously, the method for augmented reading of texts comprises detection of the portion of the text by tracking the gaze of the user.

Advantageously, the method for augmented reading of texts comprises storage of information generated by the action on the part of text.

Advantageously, according to one implementation of the invention, the various steps of the method according to the invention are implemented by software or a computer program, this software comprising software instructions which are intended to be executed by a data processor of an augmented text reader and being designed to control the execution of the various steps of this method.

The invention therefore also targets a program comprising program code instructions for executing the steps of the method for augmented reading of texts when said program is executed by a processor.

This program may use any programming language, and take the form of source code, object code or code which is intermediate between source code and object code, such as in a partially compiled form or in any other desirable form.

### BRIEF DESCRIPTION OF THE DRAWINGS

The features and advantages of the invention will become more clearly apparent upon reading the description, given by way of example, and the related figures, in which:

FIG. 1 depicts a simplified diagram of an augmented text reader according to the invention,

FIG. 2 depicts a simplified diagram of an architecture comprising an augmented text reader according to the invention,

FIG. 3 depicts a simplified diagram of a method for augmented reading of texts according to the invention.

### DESCRIPTION OF THE EMBODIMENTS

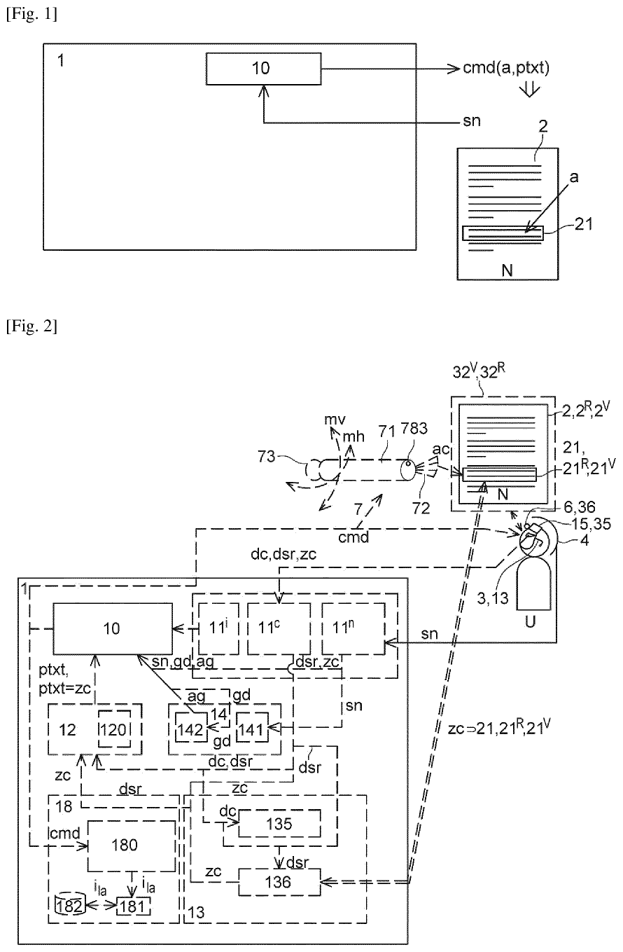

FIG. 1 depicts a simplified diagram of an augmented text reader according to the invention.

The augmented text reader 1 comprises at least one controller 10 which is able to control cmd an action ac relating to a portion of text ptxt: cmd(a, ptxt), the action ac being a function of a received neural signal sn. For example, the controller 10 controls the action ac by means of a control signal cmd: cmd(ac, ptxt).

In particular, textual content 2 is read. When the area 21 of this textual content 2 is read, if the augmented text reader 1 receives a neural signal sn then the augmented text reader 1 controls an action ac in relation to the portion of text ptxt included in this area 21.

What is meant by textual content is any physical or virtual medium comprising text, such as a paper book or e-book, a paper magazine or e-magazine, but also a paper or digital poster, physical packaging of a product, a label affixed to an object or product etc.

The user then does not manipulate the real or virtual content comprising the text in order to trigger the control of the action. This facilitates the accessibility of reading real or virtual content, including for users with a disability but also whatever the context in which the content is read by the user, notably in a work context where the user is manipulating tools etc.

FIG. 2 illustrates a simplified diagram of an architecture comprising an augmented text reader according to the invention.

The augmented text reader 1 comprises a controller 10. The controller 10 controls cmd an action ac on a portion of text ptxt. The portion of text ptxt notably corresponds to text included in an area 21, 21^{R}, 21^{V} of textual content 2, optionally real textual content 2^{R} or virtual textual content 2^{V}, respectively.

In particular, the control signal cmd controls an action ac of an interaction device on the textual content 2, notably a device for virtual interaction 3, 13 with real textual content 2^{R} or virtual textual content 2^{V}, or a device for real interaction 7 with real textual content 2^{R} or a reproduction of virtual textual content 2^{V}.

What is meant by real interaction is a physical interaction in a real environment. Notably, the physical interaction is carried out on real textual content such as a paper book, or on reproduced virtual textual content such as an e-book displayed on a tablet, a smartphone, a reader etc.

And what is meant by virtual interaction, respectively, is an interaction in a virtual environment or in a virtual part of an environment in augmented reality. For example, the virtual interaction is carried out on virtual textual content in a virtual environment, such as an e-book reproduced in virtual reality or more simply on an e-reader, or without acting directly on real textual content but in a virtual part of an environment in augmented reality superimposed on the real textual content, such as a paper book.

For example, the controlled action ac corresponds to a real gesture of the real interaction device 7^{R}, notably of an automated real device such as a robot or more simply a robotic arm or a mechanical device for manipulating real textual content 2^{R} or virtual textual content 2^{V}, notably an electrical, electronic and/or automated page-turner, notably for a paper book and/or reader.

Alternatively, the controlled action ac corresponds to a virtual gesture in a virtual environment of a virtual interaction device 3, 13 in relation to virtual textual content 2^{V} or real textual content 2^{R}, such as a function of a virtual content editor, a virtual gesture of an avatar in a virtual environment reproducing the virtual textual content and/or virtual information (such as highlighting of the text, a bookmark, a translation, a definition of the part of text etc.) generated by the virtual gesture superimposed on the real textual content etc. Notably, the generated virtual information constitutes virtual content 32^{V} superimposed on the real textual content 2^{R}.

In particular, the portion of the text ptxt is a function of gaze tracking data dₛᵣ from a user. The action ac is then carried out on the entirety of the portion of text ptxt or only a part of it. A gaze tracking device, also called a gaze detector, 5, 35, 135 detects the motion, the movement of the gaze mr of the user U.

Notably, the augmented text reader 1 receives the gaze tracking data dₛᵣ from an external gaze detector 5, 35, for example from a gaze detector 35 integrated into an augmented reality headset or glasses 3. Alternatively, the augmented text reader 1 comprises the gaze detector 135, also called a gaze tracking device, providing gaze tracking data dₛᵣ from a user.

In particular, the portion of the text ptxt is an area of text zc captured as a function of the gaze tracking data dₛᵣ. The action ac is then notably carried out on text printed on a real medium, also called real textual content.

In particular, a text sensor 6, 36, 136, such as a camera, captures an area of text 21 as a function of the gaze tracking data dₛᵣ and provides a captured area of text zc. Optionally, the gaze tracking device 5, 35, 135 and the text sensor 6, 36, 136 use the same one or more visual sensors, notably one and the same camera.

Notably, the augmented text reader 1 receives the captured area zc from an external text sensor 6, 36 for example from a text sensor 36 integrated into an augmented reality headset or glasses 3. Alternatively, the augmented text reader 1 comprises the text sensor 136, notably a camera which is able to capture an area of text zc as a function of gaze tracking data dₛᵣ. The captured area of text zc constitutes the portion of text ptxt.

In particular, the augmented text reader 1 comprises an analyzer 14, 141 which is able to determine a gesture gd of a user in relation to the portion of text ptxt as a function of the received neural signal sn.

Thus, the controlled action ac corresponds to a real action which would be carried out by the gesture gd of the user if the gesture was real and the medium of the text was real.

In particular, the gesture gd is a real or simulated gesture. Notably, the user really makes a gesture, for example with their hand, at a distance from the real or distant content, a neural interface 4 makes it possible to detect a particular neural signal sn at the instant when the gesture is made. This neural signal sn is transmitted to the analyzer 14, 141 which determines the real gesture made by the user and controls an action ac for carrying out, on the textual content, the result of the real gesture. Thus, everything happens as if the user was making this gesture directly on the textual content. If the user, either because of a disability or because their hands are already in use, cannot manipulate directly or at a distance, the user mentally simulates the gesture which they would desire to make: the gesture is then referred to as simulated. This mental simulation of the gesture triggers, in the brain of the user, a neural signal which is equivalent to the neural signal triggered by the real gesture. The neural signal sn detected during the simulated gesture is transmitted to the analyzer 14, 141 which determines the real gesture visualized mentally by the user and controls an action ac for carrying out, on the textual content, the result of the real gesture. Thus, everything happens as if the user was really making this gesture directly on the textual content. Thus, even a user in a situation where the gesture cannot really be executed may trigger the controller to control the action by mentally simulating this gesture.

In particular, the controller 10 controls one or more of the following controlled devices (which are not illustrated):
a text editor 80, 180, 380,
a translator 81, 181, 381, 781,
a dictionary 82, 182, 382, 782,
a robotic manipulator of real textual content 7^{R},
a voice synthesizer 32,
an augmented reality system 3.

Thus, the controller 10 respectively controls:
functions for editing the text, such as highlighting the part of the text, adding a note in relation to this part of the text, a bookmark etc.,
translation of the portion of the text into either a predefined language or a language selected by another neural signal,
provision of a definition of a word corresponding to the part of text, or even an encyclopedia article corresponding to the field to which the portion of text relates,
movements of a robotic manipulator, notably of a robot arm (making it possible to turn a page, close content, open content on a bookmark, introduce a bookmark, fold a page, highlight text etc.),
vocal reproduction of the text of the part of text,
reproduction, in augmented reality, of the elements generated by other controlled devices (highlighting, translation, definition, bookmark etc.).

In particular, the augmented text reader 1 comprises one or more interaction devices 3, 7, or even controlled devices such as controlled text management devices 8, 18, 38, 78, notably a text editor 80, 180, 380; a translator 81, 1801, 381, 781; and/or a dictionary 82, 1802, 382, 782; etc. Such a text management device constitutes a specific device 8, 18, 180, 38, 78, 80, 1800, 380, 81, 1801, 381, 781, 82, 1802, 382, 782 or a device implemented in a system 8, 18, 180, 38, 78. The specific text management device or text management system comprising such a text management device is either a text management device 8, 80, 81, 82 which is distinct from the devices which are used for augmented reading 1, 3, 7^{R}, or a text management device 18, 180, 1800, 1801, 1802 implemented in the augmented text reader 1, or a text management device 38, 380, 381, 382, 78, 870, 871, 872 implemented in the virtual interaction device 3 or real interaction device 7.

In particular, the reader 1 comprises a register 181 which is able to store information iₗₐ generated by implementing the action ac relating to the text. Thus, the text may be reconsulted subsequently by the user both in its published edition and in its version enriched by the user.

In particular, the reader 1 comprises a storage device 182 such as a memory or a database, also called a database of augmented reading information iₗₐ, in which the reader stores information iₗₐgenerated by implementing the action ac relating to the text. Thus, the annotations (highlighting, notes, bookmark etc.) carried out by the user by means of the augmented reader 1 may be reproduced subsequently when the textual content 2 is read again by a virtual interaction device 3.

In the case of a real interaction device 7 comprising a robotic arm, the real interaction device 7 notably comprises a manipulation device 72, an axis 73 in relation to which the manipulation device 72 may move, for example with vertical movements mv and/or horizontal movements mh, and/or a rod 71 placed between the axis 71 and the manipulation device. The manipulation device 72 is able to interact with virtual textual content 2^{V}, in particular with a device 32^{R} for reproducing the virtual textual content such as an e-reader, or with real textual content 2^{R}, notably by manipulating the pages of the real textual content 2^{R} and/or a pencil on the pages of this real textual content 2^{R} etc. The manipulation device 72 is notably a controllable gripper. Optionally, the real interaction device 7 further comprises a text management device 78 and/or a projector 783 which is optionally implemented in the text management device 78 or connected to a text management device 8, 18 which are external to the real interaction device.

Consider a user U reading text on textual content 2. The user U would like to highlight the text of the area of text 21 of this textual content 2. Either they make, at a distance from the text 2, the gesture of highlighting this area of text 21 or they mentally simulate highlighting this area of text 21. The neural interface 4 detects a neural signal sn and transmits it to the augmented text reader 1. The augmented text reader 1 receives the transmitted neural signal sn. Notably, the augmented text reader 1 comprises a receiver 11^{R} of neural signals which receives the transmitted neural signal sn. The augmented reader 1 comprises a controller 10. The controller 10 controls cmd an action ac in relation to a portion of text ptxt as a function of the received neural signal sn.

In particular, the augmented text reader 1 determines a gesture gd of the user as a function of the received neural signal sn. The determined gesture gd corresponds either to the gesture really made by the user or to the gesture mentally simulated by the user when the received neural signal sn is detected. The controller 10 then controls cmd the action ac in relation to a portion of text ptxt as a function of this determined gesture gd. Notably, the augmented text reader 1 comprises an analyzer 14, 141 which is able to determine a gesture as a function of a neural signal.

Optionally, the augmented text reader 1, or even the controller 10, generates an action ag to be controlled as a function of the received neural signal sn, or even of the determined gesture gd. In particular, the augmented text reader 1 comprises an action generator 14, 142 which is able to generate an action ag to be controlled as a function of the received neural signal sn, or even of the determined gesture gd. For example, the augmented text reader 1 comprises an action generator 14 comprising an analyzer 141 and an actual action generator 142, the analyzer 141 provides a gesture gd determined as a function of the neural signal sn to the actual action generator 142.

The augmented text reader 1 sends the control signal cmd to a real interaction device 7 or virtual interaction device 3, either directly or via a text management device 8 (which is not illustrated), 18. In particular, the augmented reader 1 comprises a control transmitter 11 which is able to transmit the control signal cmd to an external device 3, 7, 8.

In particular, the portion of text ptxt is a function of gaze tracking data dsr. Notably, the augmented text reader 1 retrieves the gaze tracking data dsr; either it receives them from an external gaze tracking device 5, 35, or it obtains them by means of an internal gaze tracking device 135.

In particular, the portion of text ptxt corresponds to an area of text zc captured as a function of the gaze tracking data dsr. Notably, the augmented text reader 1 retrieves the area of text zc as a function of gaze tracking data dsr; either it receives them from an external text sensor 6, 36, or it obtains them by means of an internal text sensor 136. The sensor 6, 36, 136 is notably a camera.

For example, the augmented text reader 1 comprises a receiver 11^{C} of captured data from a gaze tracking device 5, 35 and/or from a text sensor 6, 36. Alternatively, the augmented text reader 1 comprises a gaze tracking device 135, and/or a text sensor 136. Optionally, the augmented text reader 1 comprises a virtual interaction device 13 comprising a gaze tracking device 135, and/or a text sensor 136.

In particular, the augmented text reader 1 determines the portion of text ptxt as a function of gaze tracking data dsr, or even of an area of text zc captured on the basis of gaze tracking data dsr. Notably, the augmented text reader 1 comprises a text detector 12 which is able to determine the portion of text ptxt. Optionally, the text detector 12 comprises a character recognition device 120 which is able to extract the portion of text ptxt from an image of a captured area of text zc. Optionally, in an embodiment which is not illustrated, the text detector comprises the gaze tracking device 135 and/or the text sensor 136.

In an embodiment which is not illustrated, an augmented or virtual reality device 3 comprises a virtual interaction device 13, 33, a neural interface 34 and/or the augmented text reader 31. The virtual interaction device 13, 33 is either a virtual interaction device 33 which is distinct from the augmented text reader 1 or a virtual interaction device 13 implemented in the augmented text reader 1, 31.

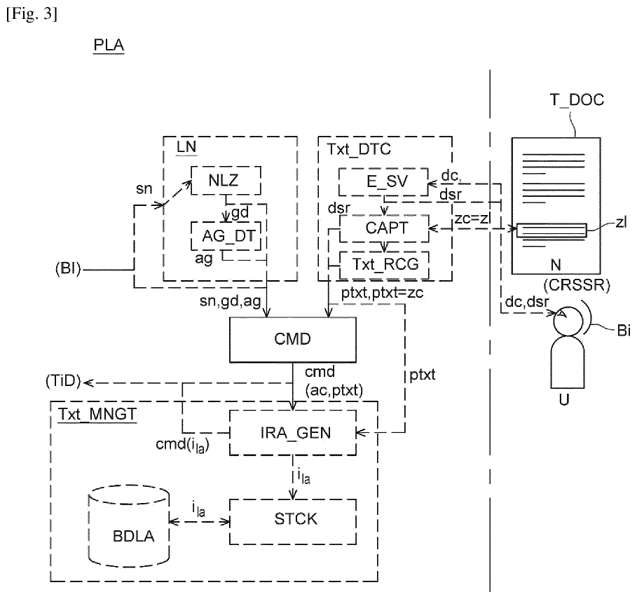

FIG. 3 illustrates a simplified diagram of a method for augmented reading of texts according to the invention.

The method for augmented reading of texts PLA comprises at least one control signal cmd for an action ac relating to a portion of text ptxt. The action ac is a function of a received neural signal sn. In particular, the control CMD controls the action ac to be carried out on the portion of text ptxt by means of a control signal cmd: cmd(ac, ptxt). The neural signal sn is notably received from a neural interface BI. The neural interface BI makes it possible, for example, to capture neural signals in the brain of the user U.

In particular, the control CMD controls an interaction device TID and/or text management Txt_MNGT. Notably, the interaction device TID is controlled by the control CMD as a function of augmented reading information iₗₐ provided by the text management Txt_MNGT: cmd(iₗₐ). In particular, the text management Txt_MNGT is implemented by the interaction device TID or comprised by the augmented reading method PLA.

In particular, the method for augmented reading of text PLA comprises analysis of neural signals NLZ detects gd the real or simulated gesture of the user U as a function of the neural signal sn received from a neural interface BI.

In particular, the augmented reading method PLA comprises action determination AG_DT, notably as a function of the detected gesture gd, for example by the analysis of neural signals NLZ. This is, for example, an action associated in advance with the detected gesture. In particular, the action determination AG_DT consults an action database BDAG (which is not illustrated) in which gesture-action pairs are stored after a gesture and an action are associated. The gesture-action pairs are, notably, either predefined or established by learning (for example, if and when the user U and/or another user is capable of making gestures directly on the textual content) etc. optionally before the augmented reading of text PLA is used or as the augmented reading of text PLA is used.

In particular, the method for augmented reading of text PLA comprises a neural link LN, also called a neural signal interface step, which makes it possible to exchange with the control CMD a signal relating to a neural signal sn received from a neural interface BI. Notably, the neural link LN provides to the control CMD an intermediate signal such as a detected gesture gd, or an associated action ag on the basis of which the control CMD controls an action ac to be carried out on the portion of text ptxt. The neural link LN comprises, for example, the analysis NLZ and/or the action determination AG_DT.

In particular, the method for augmented reading of texts PLA comprises detection of a portion of text Txt_DTC by tracking the gaze of the user dsr. Notably, gaze tracking data dsr are obtained by the detection of a portion of text Txt_DTC: for example, received from the gaze tracking device SSR or determined by gaze tracking E_SV as a function of captured eye data dc relating to the eyes of the user U. The gaze tracking E_SV is optionally comprised by the detection of a portion of text Txt_DTC or implemented by the gaze tracking device SSR. In the case where the detection of a portion of text Txt_DTC comprises the gaze tracking E_SV, they receive the captured eye data dc from an eye sensor CR.

In particular, the obtained gaze tracking data dsr are used for the capture CAPT of an area of text of textual content T_DOC, notably an area of text zl currently gazed at and/or read by the user U. The capture of an area of text CAPT provides a captured area of text zc. In the case where the capture CAPT targets an area of text zl currently gazed at and/or read by the user U, then the captured area of text zc corresponds to the area of text zl gazed at and/or read at the instant when the capture is controlled, for example by means of gaze tracking data dsr obtained at this instant. Notably, the detection of a portion of text Txt_DTC comprises the capture of an area of text CAPT. Thus, the portion of text ptxt optionally corresponds to the captured area of text zc.

In particular, the detection of a portion of text Txt_DTC comprises text recognition Txt_RCG, notably implementing recognition of written characters, such as alphabetic characters, symbols etc. in an image. The text recognition Txt_RCG notably receives the area of text zc captured as a function of the gaze tracking data dsr, for example from the capture CAPT, and recognizes a portion of text ptxt inscribed in the captured area of text zc.

In particular, the method for augmented reading of texts PLA comprises storage STCK of information ila generated by the action ac on the part of text ptxt.

In particular, the storage STCK is carried out in a storage device BDLA such as a memory or a database, also called a database of augmented reading information iₗₐ, in which the augmented reading method PLA stores STCK information iₗₐ generated by implementing the action ac relating to the text. Thus, the annotations (highlighting, notes, bookmark etc.) carried out by the user by means of the augmented reader 1 may be reproduced subsequently when the textual content 2 is read again by a virtual interaction device 3.

In particular, the method for augmented reading of text PLA comprises implementation IRA_GEN of the action ac relating to the text ptxt generating augmented reading information ila, notably a generator of augmented reading information controlled by the control signal cmd(ac, ptxt).

In particular, the method for augmented reading of text PLA comprises text management Txt_MNGT, also called text editing, implementing actions on text, optionally actions ac controlled as a function of neural signals sn. The implementation of the controlled actions ac on a portion of text ptxt generates augmented reading information iₗₐ. Optionally, the text management Txt_MNGT comprises the generation of augmented reading information IRA_GEN and/or the storage STCK.

The augmented reading information iₗₐ thus generated is optionally used, notably by the augmented reading method PLA, to control cmd(iₗₐ) a virtual or real textual interaction device TID. For example, the control signal cmd(iₗₐ) comprising the augmented reading information will control the reproduction of this augmented reading information iₗₐ by a virtual textual interaction device TID. The reproduction is notably visual and/or audio reproduction. In the case of a real textual interaction device TID, the control signal cmd(iₗₐ) comprising the augmented reading information will be converted MVT_CNV into one or more control signals for the one or more motorized elements constituting the real textual interaction device TID, either by the real textual interaction device TID itself or by the augmented reading method PLA. In particular, a control signal for motorized elements controls the movement of the motorized element: direction, distance and/or angle etc. Thus, the motorized elements of a robotic arm constituting a real textual interaction device TID may be controlled in order to turn a page in the reading direction or in the reverse reading direction, take a highlighter and horizontally or vertically highlight, in the reading direction, a portion of text with this highlighter, or fold the corner of a page, or add a bookmark etc.

The invention therefore also targets a program comprising program code instructions for executing the steps of the method for augmented reading of texts when said program is executed by a processor.

The invention also targets a medium. The information medium may be any entity or device which is capable of storing the program. For example, the medium may comprise a storage means, such as a ROM, for example a CD-ROM or a microelectronic circuit ROM, or else a magnetic storage means, for example a floppy disk or a hard disk.

On the other hand, the information medium may be a transmissible medium such as an electrical or optical signal which may be routed via an electrical or optical cable, by radio or by other means. The program according to the invention may in particular be downloaded from a network, notably the Internet.

Alternatively, the information medium may be an integrated circuit into which the program is incorporated, the circuit being adapted to execute or to be used in the execution of the method in question.

In another implementation, the invention is implemented by means of software and/or hardware components. With this in mind, the term module may correspond both to a software component and to a hardware component. A software component corresponds to one or more computer programs, one or more subroutines of a program or, more generally, to any element of a program or of software which is able to implement a function or a set of functions according to the above description. A hardware component corresponds to any element of a hardware assembly which is able to implement a function or a set of functions.

Thus, the augmented reading of text according to the invention, whether it is implemented in the form of an augmented text reader 1 or of a method for augmented reading of texts PLA, proposes to combine a neural interface 4, BI, notably in the form of a headset BCI (direct neural interface which makes it possible to control objects which are connected by thought, i.e. EEG signals) with at least gaze tracking 5, 35, 135, E_SV, SSR, also called eye tracking, or even a sensor 6, 36, 136 or capture CAPT, notably in the form of glasses which are equipped with a camera 36 and with an eye tracking (gaze tracking) system 35.

The camera 36 of the glasses detects the text on the page. This works on a paper book like on an e-book. The glasses 3 are equipped with a gaze tracking system 35, which makes it possible to know which part of the text (i.e. which words) is being read.

In order to activate a function (from among those which are possible) by thought, the user U must think about moving a limb or a muscle. Thinking about moving a body part has the same effect in the motor cortex (area of the brain) as really moving. This movement or gesture (even when simulated) of the user may therefore be detected sn via an EEG headset 4, BI the sensors of which are positioned on this brain area.

Notably by associating various movements or gestures gd, or various neural signals sn corresponding to these movements, with various actions ag, the user U mentally simulating (thinking about) raising their left arm will trigger the action ac of translating the last area of text read. In the same way, a simulated gesture of highlighting, of marking a page (for example a gesture of placing a bookmark, of folding a page) etc. of the user U will trigger the textual interaction device 3, 7, TDI to highlight, to mark the page etc.

For the bookmark function, another gesture of the user U might be associated with the marking of the page by the textual interaction device 3, è, TDI like the fact that the user, the reader U is concentrating on the page number. The camera 6, 36, 136 (used for gaze tracking) will recognize the isolated number and the information iₗₐ will be stored 181, STCK in the augmented reading device 1 or virtual or augmented reality device 3 implementing the augmented reading method PLA having a memory 182, BDLA.

The translation of a word or of a sequence of text may appear in augmented reality on the lens of the glasses or indeed be played via an audio headset.

Beyond mass-market readers with the functions mentioned above, the highlighting function may be used by technicians to store (and easily render) keywords or passwords read on hardware or operator manuals in circumstances where it is not easy to have hands free (using gloves, at the top of a pylon etc.). In the same context, easily translating certain instructions may be very useful.

1. An augmented text reader comprising:
at least one controller which is configured to control an action relating to a portion of text, the action being a function of a received neural signal.

2. The augmented text reader as claimed in claim 1, wherein the portion of the text is a function of gaze tracking data from a user.

3. The augmented text reader as claimed in claim 2, wherein the portion of the text is an area of text captured as a function of the gaze tracking data.

4. The augmented text reader as claimed in claim 2, wherein the augmented text reader comprises a gaze tracking device providing gaze tracking data from a user.

5. The augmented text reader as claimed in claim 2, wherein the augmented text reader comprises a text sensor which is able to capture an area of text as a function of gaze tracking data, the captured area of text constituting the part of text.

6. The augmented text reader as claimed in claim 1, wherein the augmented text reader comprises an analyzer which is configured to determine a gesture of a user in relation to the portion of text as a function of the received neural signal.

7. The augmented text reader as claimed in claim 7, wherein the gesture is a real or simulated gesture.

8. The augmented text reader as claimed in claim 1, wherein the controller controls one or more of the following devices:
a text editor,
a translator,
a dictionary,
a robotic manipulator of real textual content,
a voice synthesizer,
an augmented reality system.

9. The augmented text reader as claimed in claim 8, wherein the augmented text reader comprises one or more of the controlled devices.

10. The augmented text reader as claimed in claim 1, wherein the reader comprises a register which is able to store information generated by implementing the action relating to the text.

11. A method for augmented reading of texts comprising:
at least one control of an action relating to a portion of text, the action being a function of a received neural signal.

12. The method for augmented reading of texts as claimed in claim 11, wherein the reading method comprises detection of the portion of the text by tracking the gaze of the user.

13. The method for augmented reading of texts as claimed in claim 11, wherein the method comprises storage of information generated by the action on the part of text.

14. A non-transitory computer readable medium comprising a program stored thereon comprising program code instructions for executing method for augmented reading of texts when said program is executed by a processor, wherein the method comprises:
at least one control of an action relating to a portion of text, the action being a function of a received neural signal.
